(19) United States
(12) Patent Application Publication
(10) Pub. No.: US 2008/0271028 A1
(43) Pub. Date: Oct. 30, 2008

(54) INFORMATION PROCESSING APPARATUS

(75) Inventors: Yuuichiro Aso, Hamura-shi (JP); Nobuaki Inomata, Nishitama-gun (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/106,143

(22) Filed: Apr. 18, 2008

(30) Foreign Application Priority Data
Apr. 27, 2007 (JP) 2007-120100

(51) Int. Cl. G06F 9/46

(52) U.S. Cl. 718/103

(57) ABSTRACT

According to one embodiment, an information processing apparatus, executing a process including a plurality of threads for reproduction of moving image data, includes a storage unit which stores priority information indicating a priority of a process of each of threads upon executing the process of the plurality of threads, and a processing unit which reads the priority information from the storage unit, reads the read priority information as a definition file, and executes the process of each of the threads in accordance with the priority information of the definition file.

### CROSS-REFERENCE TO RELATED APPLICATIONS

This application is based upon and claims the benefit of priority from Japanese Patent Application No. 2007-120100, filed Apr. 27, 2007, the entire contents of which are incorporated herein by reference.

### BACKGROUND

1. Field

One embodiment of the invention relates to an information processing apparatus such as a personal computer and, more particularly, to an information processing apparatus having a moving image reproducing function.

2. Description of the Related Art

In general, in software supporting media reproduction such as HD DVD or the like, a moving image data reproducing process is composed of a plurality of threads for executing processes such as reading and decoding moving image data and rendering images. Scheduling of each of the threads depends on an operating system. At this time, a sufficient time may not be spent for important processes such as streaming and system performance may be deteriorated. For example, during an image rendering thread process, interruption of the other threads may occur, images may not be drawn at a real time and thus the frame drop may occur. As a solution of this problem, priorities of the threads are set in the operating system, higher priorities are set for the threads for carrying out important processes such as rendering images and they are operated with higher priorities. For example, Jpn. Pat. Appln. KOKAI Publication No. 11-237993 discloses a method of processing a plurality of threads by setting priority information for each device type.

According to this technique, however, when settings of the priority information are changed, rebuilding needs to be carried out again and is complicated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing an appearance of a computer according to an embodiment of the present invention;

FIG. 2 is a block diagram showing a system configuration of the computer according to the embodiment of the present invention;

FIG. 3 is a block diagram showing a functional configuration of a moving image reproducing application according to the embodiment of the present invention;

FIG. 4 is a flowchart showing a control method of the computer according to the embodiment of the present invention; and

FIG. 5 is a table of parameter sets.

### DETAILED DESCRIPTION

Various embodiments according to the invention will be described hereinafter with reference to the accompanying drawings. In general, according to one embodiment of the invention, an information processing apparatus, executing a process including a plurality of threads for reproduction of moving image data, includes: a storage unit which stores priority information indicating a priority of a process of each of threads upon executing the process of the plurality of threads; and a processing unit which reads the priority information from the storage unit, reads the read priority information as a definition file, and executes the process of each of the threads in accordance with the priority information of the definition file.

An embodiment of the present invention will be described below with reference to the accompanying renderings.

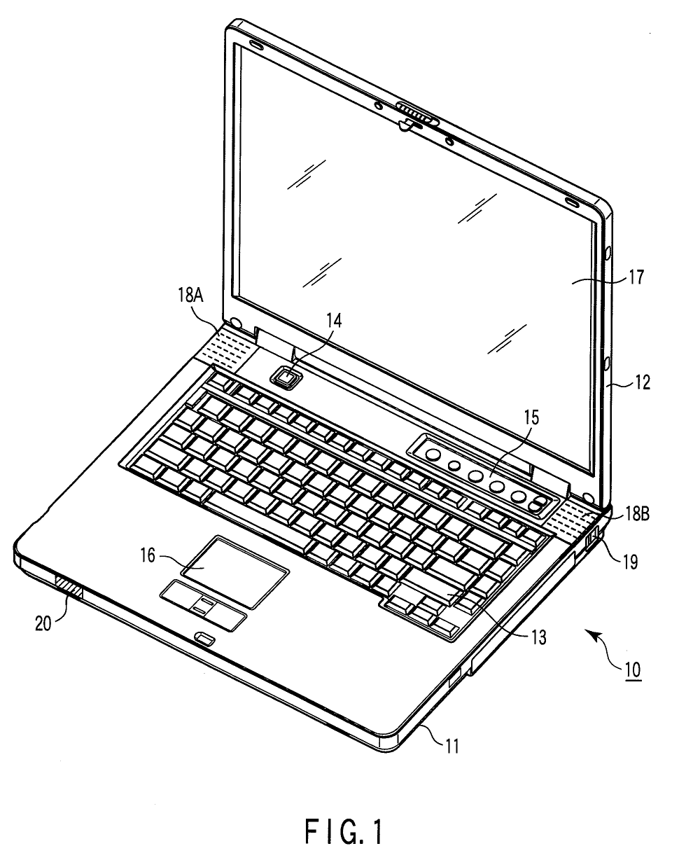

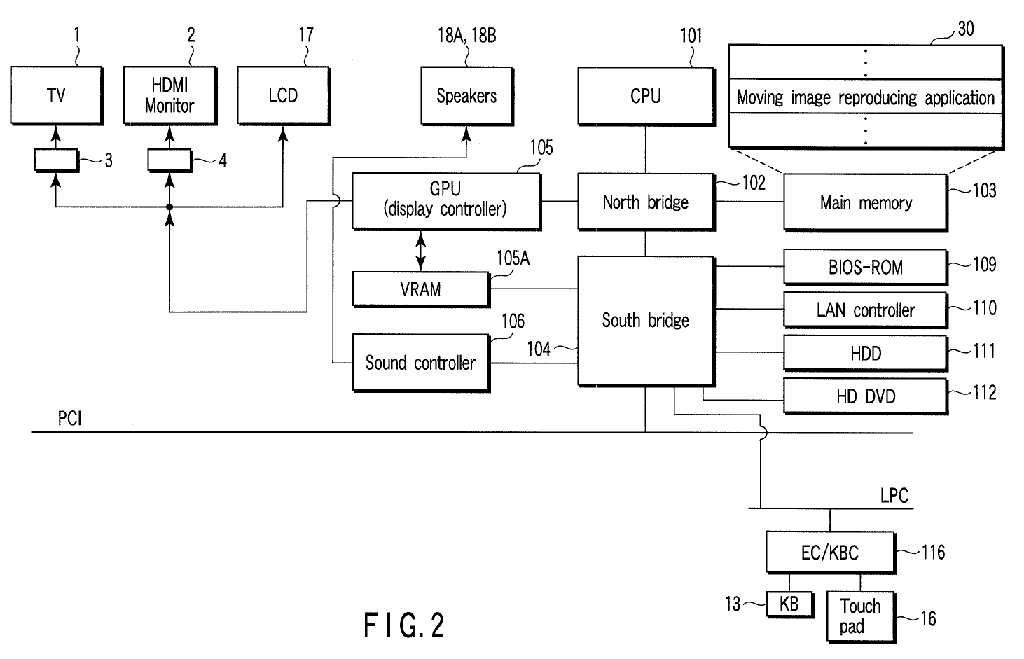

First, a configuration of an information processing apparatus according to the embodiment of the present invention is described with reference to FIG. 1 and FIG. 2. The information processing apparatus is implemented as, for example, a notebook computer 10.

FIG. 1 is a perspective view showing the notebook computer 10 with a display unit opened.

The computer 10 is composed of a computer main body 11 and the display unit 12. A display device composed of a TFT-LCD (Thin Film Transistor Liquid Crystal Display) 17 is embedded in the display unit 12. A display screen of the LCD 17 is located approximately at the center of the display unit 12.

The display unit 12 is attached to the main body 11 so as to freely pivot between an opened position and a closed position. The main body 11 has a housing shaped in a thin box. On a top face of the housing, a keyboard 13, a power button 14 for power-on/power-off of the computer 10, an input operation panel 15, a touch pad 16, speakers 18A and 18B and the like are arranged.

The input operation panel 15 is an input unit which inputs events corresponding to pushed buttons, and comprises a plurality of buttons for activating a plurality of functions, respectively. A group of these buttons also includes an operation button for controlling a TV function of the computer 10.

A remote-control unit interface unit 20 for executing communication with a remote-control unit which controls the TV function of the computer 10 is provided on a front face of the main body 11.

The computer 10 is capable of receiving and reproducing broadcast program data such as ground-wave digital TV broadcasting. An antenna terminal 19 for ground-wave digital TV broadcasting is provided on a right side face of the main body 11.

Next, the system configuration of the computer 10 is described with reference to FIG. 2.

As shown in FIG. 2, the computer 10 comprises a CPU 101, a north bridge 102, a main memory 103, a south bridge 104, a graphics processing unit (GPU) 105, a video memory (VRAM) 105A, a sound controller 106, a BIOS-ROM 109, a LAN controller 110, a hard disk drive (HDD) 111, an HD DVD drive 112, an Internet connecting unit 114, an embedded controller/keyboard controller IC (EC/KBC) 116, and the like.

The CPU 101 is a processor which controls the operations of the computer 10, and executes the operating system, a moving image reproducing application 30 and the like that are loaded on the main memory 103 from the hard disk drive (HDD) 111. In addition, the CPU 101 also executes the BIOS (Basic Input Output System) stored in the BIOS-ROM 109. The BIOS is a program for controlling the hardware.

The north bridge 102 is a bridge device which makes a connection between a local bus of the CPU 101 and the south bridge 104. A memory controller for controlling access to the main memory 103 is also built in the north bridge 102. The north bridge 102 also has a function of executing communication with the GPU 105 via a serial bus or the like of the PCI EXPRESS standards.

The GPU 105 is a display controller which controls the LCD 17 employed as a display monitor of the computer 10. A display signal generated by the GPU 105 is transmitted to the LCD 17. The display signal can also be transmitted to an external TV1 and an external HDMI monitor via interfaces 3 and 4 provided on the main body 11, respectively.

The south bridge 104 controls the devices on an LPC (Low Pin Count) bus, and devices on a PCI (Peripheral Component Interconnect) bus. An IDE (Integrated Drive Electronics) controller for controlling the HDD 111 and the DVD drive 112 is built in the south bridge 104. Moreover, the south bridge 104 also has a function of executing communication with the sound controller 106.

The sound controller 106 is a sound source device, and outputs audio data to be reproduced to the speakers 18A and 18B.

The embedded controller/keyboard controller IC (EC/KBC) 116 is a one-chip microcomputer on which an embedded controller for power management and a keyboard controller for controlling the keyboard (KB) 13 and the touch pad 16 are integrated. The embedded controller/keyboard controller IC (EC/KBC) 116 has a function of controlling power-on/power-off of the computer 10, in response to the user's operation of the power button. The embedded controller/keyboard controller IC (EC/KBC) 116 also has a function of executing communication with the remote-control unit interface 20.

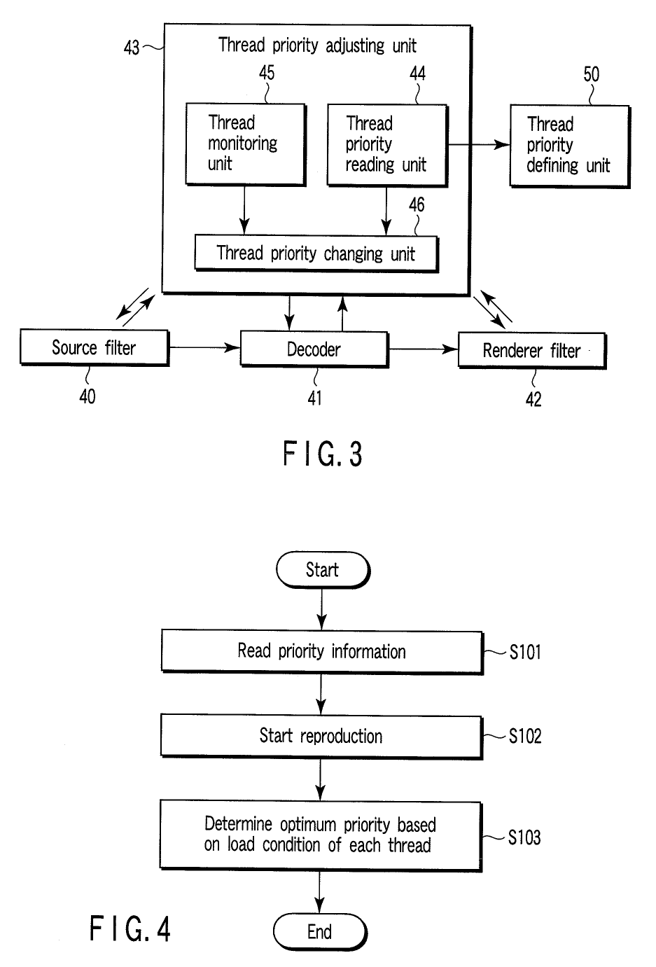

Next, FIG. 3 is a block diagram showing a functional configuration of the moving image reproducing application.

The moving image reproducing application 30 comprises a source filter 40, a decoder 41, a renderer filter 42, a thread priority adjusting unit 43, a thread priority defining unit 50 such as a register, and the like. The thread priority adjusting unit 43 comprises a thread monitoring unit 45, a thread priority reading unit 44 and a thread priority changing unit 46.

The source filter 40 executes management and transmission of moving image data to be decoded. The decoder 41 executes decoding of moving image data. The renderer filter 42 executes rendering of the decoded moving image data. The thread priority adjusting unit 43 controls priority of each of thread processes. The thread priority defining unit 50 is a registry or the like that stores a parameter set of the priority information of each thread process as a table. In the present embodiment, the parameter set of the priority information is not installed by apparatus type and set, but is read out from the outside such as a registry or the like as a definition file. The thread monitoring unit 45 monitors a load condition of each thread process and determines an optimum priority. The thread priority reading unit 44 reads out preliminarily defined thread process priority information from the thread priority defining unit 50. The thread priority changing unit 46 sets the priority of the thread in accordance with the priority information of each thread process.

Next, a control method to which the information processing apparatus according to the embodiment of the present invention is applied is described with reference to a flowchart of FIG. 4. In the present invention, for example, the following two processes can be conceived, but Mode 1 is described in the present embodiment.

1. Preliminarily reading out a default parameter set of the priority information, and changing the parameter set in accordance with a load condition of each thread.

2. Preliminarily reading out a parameter set of the priority information, and executing a thread process with the parameter set (not changing the parameter set in accordance with the load condition of the thread).

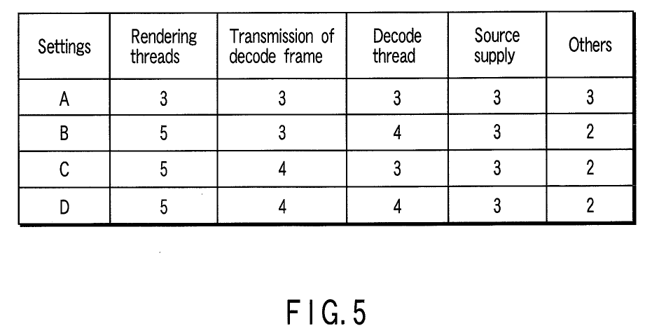

First, a parameter set of each thread as shown in FIG. 5 is preliminarily stored in the thread priority defining unit 50 serving as the registry or the like. For example, four settings “Setting A” to “Setting D” are stored.

The CPU 101 loads the moving image reproducing application 30 from the HDD 111 to the main memory 103. The thread priority reading unit 44 of the thread priority adjusting unit 43 of the moving image reproducing application 30 reads out the parameter set of the preliminarily defined thread process priority information from the thread priority defining unit 50 (block S101). For example, as for the parameter set of the thread process priority information, a plurality of setting parameter sets A to D are stored in a table as shown in FIG. 5. For example, if default setting is “Setting B”, “Setting B” is read out and set by the thread priority changing unit 46 in step S101. In “Setting B”, for example, a rendering thread (process) of moving image data is set at propriety 5, transmission (process) of the decode frame is set at priority 3, a decode thread (process) is set at priority 4, a supply (process) of a moving image data source is set at priority 3 and the other process (rendering process of user interface, and the like) is set at priority 2.

Subsequently, the moving image reproducing application 30 starts the moving image reproducing process (block S102). The above thread processes, i.e. the rendering thread of moving image data, the transmission of the decode frame, the supply of the moving image data source, and the other process are executed sequentially. The source filter 40 executes management and transmission of the moving image data to be decoded (supply of the source and transmission of the decode frame). The decoder 41 executes decoding of moving image data (decode thread). The renderer filter 42 executes rendering of the decoded moving image data (rendering thread). The thread monitoring unit 45 of the thread priority adjusting unit 43 determines the optimum priority on the basis of the load condition of each of the threads (processes) (block S103). For example, if frame drop occurs in the reproduction of the moving image data in the status of “Setting B”, the priority of the transmission (process) of the decode frame is increased by reading out the definition of “Setting C”. After the optimum priority (parameter set) has been determined, the optimum priority (parameter set), i.e. “Setting C” can be read as the default parameter set in block S101.

Thus, in a system such as a HD DVD player which executes the process while providing a timing with a plurality of threads, balance of thread priorities according to the importance of each process is essential. In the present embodiment, balance of the thread priorities can be maintained optimally in the system. For example, there are a method of reading and determining a parameter set of the thread priority determined preliminarily by measurement or the like at the operation, and a method of automatically adjusting each thread priority at an optimum value by considering the system conditions. Accuracy can be set higher with the parameter determined preliminarily by measurement, but the automatic adjustment function is effective in an uncertain environment.

Thus, by employing the present invention, the priorities of the thread process can be properly changed, without executing a rebuilding process, by reading definition files (parameters) in accordance with load conditions for reproduction of the moving image data.

The present embodiment has been described in relation to the personal computer 10, but is not limited to this. The present invention can also be applied to devices having the moving image reproducing function of the HD DVD player and the like.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus configured to execute a process comprising a plurality of threads for reproduction of moving image data, the information processing apparatus comprising:
a storage unit configured to store priority information that indicates a process priority for each of the plurality of threads upon execution of the process; and
a processing unit configured to read the priority information from the storage unit as a definition file, and to execute the process in accordance with the priority information of the definition file.

2. The apparatus of claim 1, wherein the storage unit is configured to store the priority information as a plurality of parameter sets, and wherein the processing unit comprises a monitoring unit configured to monitor the process,to read a parameter set of predetermined priority information from the storage unit in accordance with a status of the process, and to execute the process in accordance with the read priority information.

3. The apparatus of claim 1, wherein the storage unit comprises a registry.

4. The apparatus of claim 1, wherein the processing unit is configured to execute the process in accordance with priority information of a predetermined parameter set according to a load condition of one or more threads within the process.

5. The apparatus of claim 1, wherein the processing unit is configured to set priority information of an appropriate parameter set according to a load condition of one or more threads within the process as a default.
